(19) United States
(12) Patent Application Publication
(10) Pub. No.: US 2016/0264079 A1
(43) Pub. Date: Sep. 15, 2016

(54) CAR DOOR OPENING DETECTION SYSTEM AND METHOD THEREOF

(71) Applicant: proeasy network solutions co., LTD., Hsinchu County (TW)

(72) Inventor: Hsing-Hung Lu, Hsinchu County (TW)

(21) Appl. No.: 14/732,779

(22) Filed: Jun. 8, 2015

(30) Foreign Application Priority Data
Mar. 10, 2015 (TW) 104107588

(51) Int. Cl. B60R 16/03

(52) U.S. Cl. CPC B60R 16/03

(57) ABSTRACT

A car door opening detection system and a method thereof are provided. The car door opening detection system includes a transmitter, a sensor, and a control unit. The transmitter is electrically connected to a car circuit of a car. The car circuit is electrically connected to a power source of the car. When a car door of the car is opened, the car circuit is turned on to receive a power from the power source, and the transmitter is enabled to transmit an infrared (IR) signal. The sensor is disposed within the car and faces the transmitter. The sensor receives the IR signal and transmits a corresponding digital signal in response to the IR signal. The control unit is coupled to the sensor and receives the corresponding digital signal. When the corresponding digital signal is classified as a predetermined pattern, the control unit identifies that the car door is opened.

### CROSS-REFERENCE TO RELATED APPLICATION

This application claims the priority benefit of Taiwan application serial no. 104107588, filed on Mar. 10, 2015. The entirety of the above-mentioned patent application is hereby incorporated by reference herein and made a part of this specification.

### BACKGROUND OF THE INVENTION

1. Field of the Invention

The invention relates to an automobile anti-theft technology and more particularly relates to a car door opening detection system and a method thereof.

2. Description of Related Art

Cars are the most important means of transportation for modern people. Generally, to prevent theft, locks or anti-theft devices are usually installed on cars to prevent cars from being stolen. Locks are more troublesome to use, while anti-theft devices require professional personnel to assist with installation. Anti-theft devices that can be conveniently installed and used by users independently become a subject that persons skilled in the art are committed to develop.

### SUMMARY OF THE INVENTION

The invention provides a car door opening detection system, which uses an infrared technology to detect a car door open status to achieve the purpose of theft prevention.

According to an exemplary embodiment of the present invention, a car door opening detection system including a transmitter, a sensor, and a control unit is provided. The transmitter is electrically connected to a car circuit of a car. The car circuit is electrically connected to a power source of the car, and when at least one car door of the car is opened, the car circuit is turned on to receive a power from the power source, and the transmitter is enabled to transmit an infrared signal. The sensor is disposed within the car and faces the transmitter. The sensor receives the infrared signal and transmits a corresponding digital signal in response to the infrared signal. The control unit is coupled to the sensor. The control unit receives the corresponding digital signal, and when the corresponding digital signal is classified as a predetermined pattern, identifies that the at least one car door of the car is opened.

In an exemplary embodiment of the invention, the control unit decodes the corresponding digital signal to obtain a signal code. In addition, the control unit determines whether the signal code is the same as a predetermined code value, and when the signal code is the same as the predetermined code value, the control unit identifies that the corresponding digital signal is classified as the predetermined pattern and identifies that at least one car door of the car is opened.

In an exemplary embodiment of the invention, the sensor obtains a light intensity value according to the corresponding digital signal, and determines whether the light intensity value is larger than an intensity threshold. When the light intensity value is larger than the intensity threshold, the control unit identifies that the corresponding digital signal is classified as the predetermined pattern and identifies that at least one car door of the car is opened.

In an exemplary embodiment of the invention, the car door opening detection system further comprises a communication module, wherein when the control unit identifies that the at least one car door of the car is opened, the control unit sends out a warning message to a wireless communication device through the communication module.

In an exemplary embodiment of the invention, the transmitter further comprises at least one infrared light-emitting diode, wherein the transmitter drives the at least one infrared light-emitting diode to transmit the infrared signal.

In an exemplary embodiment of the invention, the transmitter further comprises a plurality of infrared light-emitting diodes and a plurality of visible light sources, and the number of the infrared light-emitting diodes is equal to the number of the visible light sources.

In an exemplary embodiment of the invention, the sensor further comprises a light-filtering module to filter out a visible light.

In an exemplary embodiment of the invention, the car circuit is a car door switch circuit.

In an exemplary embodiment of the invention, the car circuit is a car light circuit.

According to an exemplary embodiment of the present invention, a car door opening detection method for a car door opening detection system is provided. The car door opening detection system comprises a transmitter and a sensor. The sensor is disposed within a car and faces the transmitter. The car door opening detection method comprises: electrically connecting the transmitter to a car circuit of the car, wherein the car circuit is electrically connected to a power source of the car, and when at least one car door of the car is opened, the car circuit is turned on to receive a power from the power source, and the transmitter is enabled to transmit an infrared signal. The car door opening detection method also comprises receiving the infrared signal and transmitting a corresponding digital signal in response to the infrared signal by the sensor; and receiving the corresponding digital signal, and when the corresponding digital signal is classified as a predetermined pattern, identifying that the at least one car door of the car is opened.

In an exemplary embodiment of the invention, the car door opening detection method further comprises: decoding the corresponding digital signal to obtain a signal code; determining whether the signal code is the same as a predetermined code value; and when the signal code is the same as the predetermined code value, identifying that the corresponding digital signal is classified as the predetermined pattern and identifying that the at least one car door of the car is opened.

In an exemplary embodiment of the invention, the car door opening detection method further comprises: obtaining a light intensity value according to the corresponding digital signal by the sensor, and determining whether the light intensity value is larger than an intensity threshold; and when the light intensity value is larger than the intensity threshold, identifying that the corresponding digital signal is classified as the predetermined pattern and identifying that the at least one car door of the car is opened.

In an exemplary embodiment of the invention, the car door opening detection method further comprises: when identifying that the at least one car door of the car is opened, sending out a warning message to a wireless communication device through a communication module.

In an exemplary embodiment of the invention, the transmitter further comprises at least one infrared light-emitting diode. The transmitter drives the at least one infrared light-emitting diode to transmit the infrared signal.

In an exemplary embodiment of the invention, the transmitter further comprises a plurality of infrared light-emitting diodes and a plurality of visible light sources, and the number of the infrared light-emitting diodes is equal to the number of the visible light sources.

In an exemplary embodiment of the invention, the sensor further comprises a light-filtering module to filter out a visible light.

In an exemplary embodiment of the invention, the car circuit is a car door switch circuit.

In an exemplary embodiment of the invention, the car circuit is a car light circuit.

Accordingly, by electrically connecting the transmitter to the car circuit, when the car door is opened, the car door opening detection method and system of the invention can turn on the transmitter to transmit the infrared signal, and through the sensor receiving the infrared signal, determine the open status of the car door after identifying the infrared signal. Thus, a user is allowed to conveniently and easily learn of the car door status in order to achieve the purpose of theft prevention.

To make the above and other features and advantages of the invention more comprehensible, embodiments accompanied with drawings are described in detail as follows.

### BRIEF DESCRIPTION OF THE DRAWINGS

The accompanying drawings are included to provide a further understanding of the invention, and are incorporated in and constitute a part of this specification. The drawings illustrate exemplary embodiments of the invention and, together with the description, serve to explain the principles of the invention.

FIG. 1 is a block diagram of a car door opening detection system illustrated according to an exemplary embodiment of the invention.

FIG. 2 is a flow diagram of a car door opening detection method illustrated according to an exemplary embodiment of the invention.

FIG. 3 is a flow diagram of a car door opening detection method illustrated according to an exemplary embodiment of the invention.

FIG. 4 is a flow diagram of a car door opening detection method illustrated according to an exemplary embodiment of the invention.

FIG. 5 is a block diagram of a car door opening detection system illustrated according to another exemplary embodiment of the invention.

FIG. 6 is a flow diagram of a car door opening detection method illustrated according to an exemplary embodiment of the invention.

### DESCRIPTION OF THE EMBODIMENTS

FIG. 1 is a block diagram of a car door opening detection system illustrated according to an exemplary embodiment of the invention.

Referring to FIG. 1, the car door opening detection system 10 includes a transmitter 110, a sensor 120, and a control unit 130.

The transmitter 110 is electrically connected to a car circuit of a car. The car circuit can be a car door switch circuit or a car light circuit. In the exemplary embodiment, for example, the transmitter 110 is an infrared transmitter. For example, the transmitter 110 includes at least one infrared light-emitting diode, and the transmitter 110 drives the infrared light-emitting diode to transmit an infrared (IR) signal 105. In another exemplary embodiment, the transmitter 110 includes a plurality of infrared light-emitting diodes and a plurality of visible light sources, wherein the visible light sources are, for example, common light-emitting diode light sources. For example, the transmitter 110 can be disposed as a car light fixture, such as an interior light and a car door light. In addition, the number of the infrared light-emitting diodes is equal to the number of the visible light sources to ensure that the intensity of the IR signal 105 is sufficient to be received. More specifically, the car circuit is electrically connected to a power source of the car. When at least one car door of the car is opened, the car circuit is turned on to receive a power from the power source of the car, and the transmitter 110 is enabled to transmit the IR signal 105. For example, in the case where the car circuit is a car light circuit, when the at least one car door of the car is opened, the car circuit is turned on to turn on the car light, while the transmitter 110 is enabled to transmit the IR signal 105.

The sensor 120 is disposed within the car and faces the transmitter 110, and is within a transmitting range of the transmitter 110. In the exemplary embodiment, the sensor 120 is an infrared sensor. In other words, the sensor 120 receives the IR signal 105 transmitted by the transmitter 110 and transmits a corresponding digital signal in response to the IR signal 105. Furthermore, the sensor 120 includes a light-filtering module to filter out a visible light in order to prevent malfunction of the sensor 120. The sensor 120, for example, filters out sunlight and fluorescence.

The control unit 130 is coupled to the sensor 120. The control unit 130 is, for example, a central processing unit (CPU), a programmable microprocessor, an embedded control chip, etc. In the exemplary embodiment, the control unit 130 identifies whether the car door is opened according to the corresponding digital signal received.

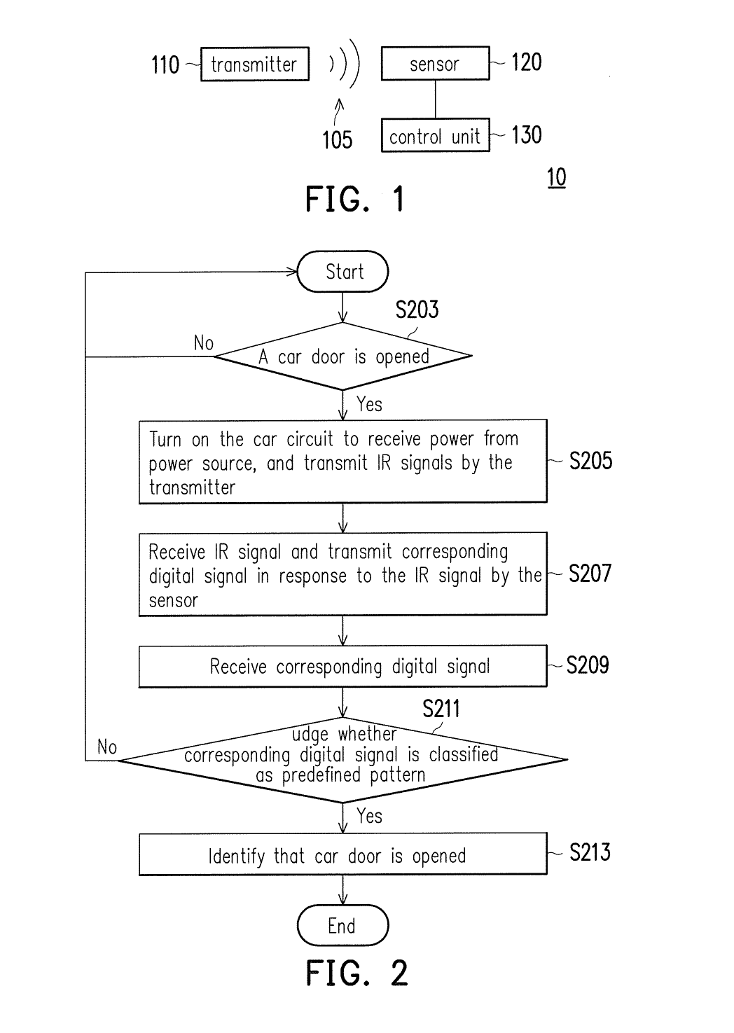

FIG. 2 is a flow diagram of a car door opening detection method illustrated according to an exemplary embodiment of the invention.

Referring to FIG. 2, in step S203, when at least one car door of a car is opened, as shown in step S205, a car circuit is turned on to receive a power from a power source of the car, and the transmitter 110 is enabled to transmit the IR signal 105.

Then, in step S207, the sensor 120 receives the IR signal 105 transmitted by the transmitter 110 and transmits a corresponding digital signal in response to the IR signal 105. More specifically, the sensor 120 converts the IR signal 105 received into the corresponding digital signal and transmits the corresponding digital signal to the control unit 130.

In step S209, the control unit 130 receives the corresponding digital signal, and in step S211, the control unit 130 determines whether the corresponding digital signal is classified as a predetermined pattern. When the corresponding digital signal is classified as the predetermined pattern, in step S213, the control unit 130 identifies that the at least one car door of the car is opened.

More specifically, the IR signal 105 is an infrared beam. In addition, the IR signal 105 uses pulse-width modulation (PWM) to perform encoding, thereby becoming an infrared beam having a specific encoded control signal. In the exemplary embodiment, the predetermined pattern is, for example, a predetermined code value or a threshold. For example, in the case where the predetermined pattern is a predetermined code value, the predetermined code value is, for example, an encoded value containing alphanumeric characters for comparison with the decoded IR signal 105 to confirm that the signal received is the IR signal 105 transmitted from the transmitter 110 and not other sources of interference. In the case where the predetermined pattern is an intensity threshold, the intensity threshold is, for example, a numerical value for comparison with the beam intensity of the IR signal 105 to confirm that the signal received is the IR signal 105 transmitted from the transmitter 110 and not other sources of interference. The following paragraphs provide several exemplary embodiments as descriptions.

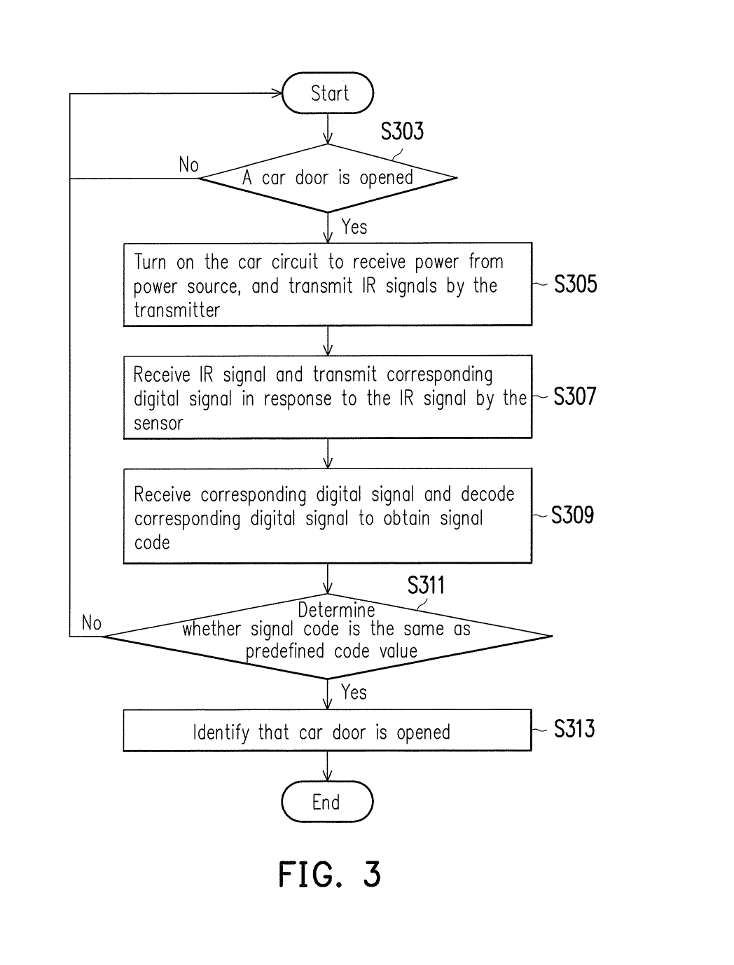

FIG. 3 is a flow diagram of a car door opening detection method illustrated according to an exemplary embodiment of the invention. The exemplary embodiment uses pulse-width modulation (PWM) to perform encoding and generates the IR signal 105 having a specific encoded control signal.

Referring to FIG. 3, in step S303, when at least one car door of a car is opened, as shown in step S305, a car circuit is turned on to receive a power from a power source of the car, and the transmitter 110 is enabled to transmit an infrared beam having the specific encoded control signal to serve as the IR signal 105. The IR signal 105 is continuously transmitted in a package form.

Then, in step S307, the sensor 120 receives the IR signal 105 transmitted by the transmitter 110 and transmits a corresponding digital signal in response to the IR signal 105. More specifically, the IR signal 105 received by the sensor 120 is a continuous packages, and the sensor 120 identifies a complete specific encoded control signal from the packets and converts the same into the corresponding digital signal. Afterwards, the sensor 120 transmits the corresponding digital signal to the control unit 130 in response to the IR signal 105.

Then, in step S309, the control unit 130 receives the corresponding digital signal. At this time, the corresponding digital signal is the specific encoded control signal, and thereby the control unit 130 decodes the corresponding digital signal to obtain a signal code. For example, the corresponding digital signal (the specific encoded control signal) is decoded according to a lookup table to obtain the signal code. Here, the signal code can be an encoded value containing alphanumeric characters.

In step S311, the control unit 130 determines whether the signal code is the same as a predetermined code value (namely, a predetermined pattern). When the signal code is the same as the predetermined code value, in step S313, the control unit 130 identifies that the corresponding digital signal is classified as the predetermined pattern and identifies that the at least one car door of the car is opened.

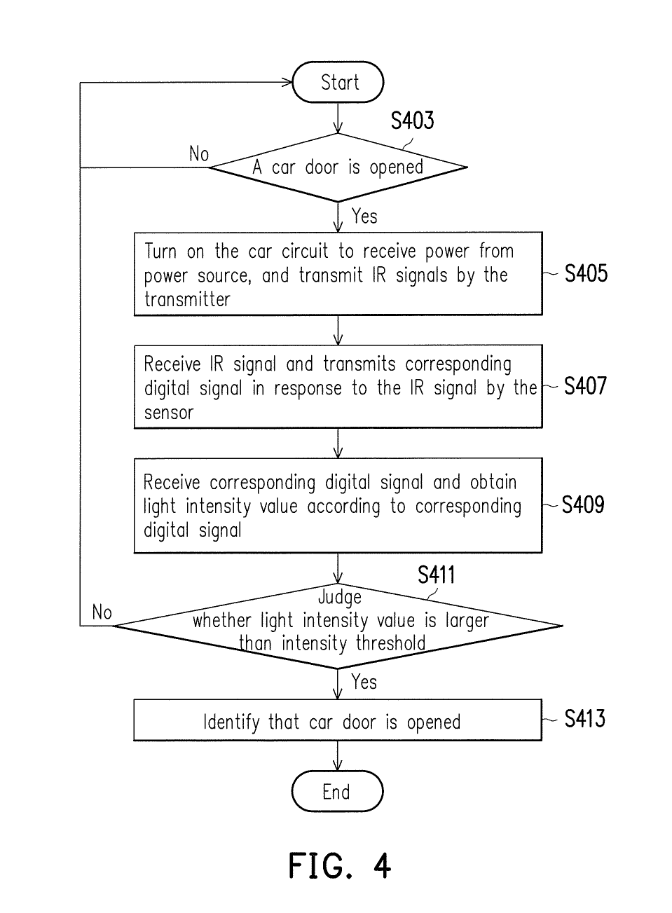

FIG. 4 is a flow diagram of a car door opening detection method illustrated according to an exemplary embodiment of the invention. In the exemplary embodiment, a corresponding digital signal is generated by a light intensity value of an infrared beam.

Referring to FIG. 4, in step S403, when at least one car door of a car is opened, as shown in step S405, a car circuit is turned on to receive a power from a power source of the car, and the transmitter 110 is enabled to transmit an infrared beam having a specific intensity to serve as the IR signal 105.

Then, in step S407, the sensor 120 receives the IR signal 105 transmitted by the transmitter 110, generates a corresponding digital signal according to the light intensity value of the IR signal 105 received, and transmits the corresponding digital signal to the control unit 130 in response to the IR signal 105.

In step S409, the control unit 130 receives the corresponding digital signal, and obtains the light intensity value of the IR signal 105 according to the corresponding digital signal.

In step S411, the control unit 130 determines whether the light intensity value is larger than an intensity threshold (namely, a predetermined pattern). When the light intensity value is larger than the intensity threshold, as shown in step S413, the control unit 130 identifies that the corresponding digital signal is classified as the predetermined pattern and identifies that the at least one car door of the car is opened.

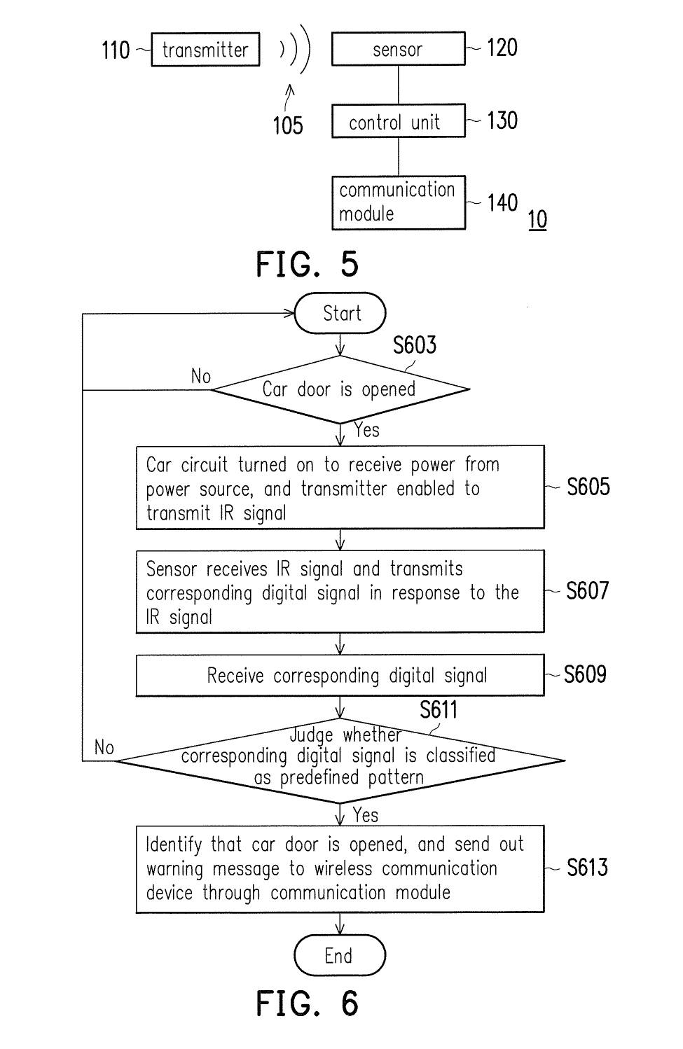

FIG. 5 is a block diagram of a car door opening detection system illustrated according to another exemplary embodiment of the invention.

Referring to FIG. 5, in the exemplary embodiment, the car door opening detection system 10 further includes a communication module 140.

The communication module 140 is coupled to the control unit 130. The communication module 140 can be a communication chip supporting one or a combination of a global system for mobile communication (GSM) system, personal handy-phone system (PHS), code division multiple access (CDMA) system, wireless fidelity (WiFi) system, worldwide interoperability for microwave access (WiMAX) system, third-generation wireless communications technology (3G), long term evolution (LTE), etc.

In the exemplary embodiment, when the control unit 130 identifies that at least one car door of a car is opened, the control unit 130 sends out a warning message to a wireless communication device through the communication module 140. In the exemplary embodiment, the wireless communication device is, for example, a cell phone, personal digital assistant (PDA), a smart phone, etc., and the invention does not limit the types of wireless communication device.

FIG. 6 is a flow diagram of a car door opening detection method illustrated according to an exemplary embodiment of the invention.

Referring to FIG. 6, in step S603, when at least one car door of a car is opened, as shown in step S605, a car circuit is turned on to receive a power from a power source of the car, and the transmitter 110 is enabled to transmit the IR signal 105.

Then, in step S607, the sensor 120 receives the IR signal 105 transmitted by the transmitter 110 and transmits a corresponding digital signal in response to the IR signal 105. More specifically, the sensor 120 converts the IR signal 105 received into the corresponding digital signal and transmits the corresponding digital signal to the control unit 130.

In step S609, the control unit 130 receives the corresponding digital signal, and in step S611, the control unit 130 determines whether the corresponding digital signal is classified as a predetermined pattern. When the corresponding digital signal is classified as the predetermined pattern, in step S613, the control unit 130 identifies that the at least one car door of the car is opened and sends out a warning message to a user's wireless communication device through the communication module 140. More specifically, the warning message is, for example, sent as a short message, an e-mail, a text message, etc. to the user's wireless communication device, and the invention does not limit the types of warning message.

In summary of the above, by electrically connecting the infrared transmitter to the car circuit, when the car door is opened, the car door opening detection system and method of the invention can turn on the transmitter to transmit the IR signal, and through the sensor receiving the IR signal, determine the open status of the car door after identifying the IR signal. Furthermore, the car door opening detection system and method of the invention can convert the IR signal into the corresponding digital signal, obtain the signal code after decoding the corresponding digital signal, and determine the open status of the car door according to the signal code. Moreover, the car door opening detection system and method of the invention can convert the IR signal into the corresponding digital signal, obtain the light intensity value according to the corresponding digital signal, and then determine the open status of the car door according to the light intensity value. In addition, the car door opening detection system and method of the invention can transmit to the user's wireless communication device the warning message with the status after car door detection. The car door opening detection system and method of the invention allows the user to conveniently and easily learn of the car door status in order to achieve the purpose of theft prevention.

Although the present invention has been described with reference to the above embodiments, it will be apparent to those skilled in the art that various modifications and variations can be made to the disclosed embodiments without departing from the scope or spirit of the invention. In view of the foregoing, it is intended that the invention covers modifications and variations provided that they fall within the scope of the following claims and their equivalents.

What is claimed is:

1. A car door opening detection system, comprising:
a transmitter electrically connected to a car circuit of a car, wherein the car circuit is electrically connected to a power source of the car, and when at least one car door of the car is opened, the car circuit is turned on to receive a power from the power source, and the transmitter is enabled to transmit an infrared signal;
a sensor disposed within the car and facing the transmitter, wherein the sensor receives the infrared signal and transmits a corresponding digital signal in response to the infrared signal; and
a control unit coupled to the sensor, wherein the control unit receives the corresponding digital signal, and when the corresponding digital signal is classified as a predetermined pattern, identifies that the at least one car door of the car is opened.

2. The car door opening detection system according to claim 1, wherein the control unit decodes the corresponding digital signal to obtain a signal code,
wherein the control unit determines whether the signal code is the same as a predetermined code value, and when the signal code is the same as the predetermined code value, the control unit identifies that the corresponding digital signal is classified as the predetermined pattern and identifies that the at least one car door of the car is opened.

3. The car door opening detection system according to claim 1, wherein the sensor obtains a light intensity value according to the corresponding digital signal, and determines whether the light intensity value is larger than an intensity threshold,
wherein when the light intensity value is larger than the intensity threshold, the control unit identifies that the corresponding digital signal is classified as the predetermined pattern and identifies that the at least one car door of the car is opened.

4. The car door opening detection system according to claim 1, further comprising a communication module, wherein when the control unit identifies that the at least one car door of the car is opened, the control unit sends out a warning message to a wireless communication device through the communication module.

5. The car door opening detection system according to claim 1, wherein the transmitter further comprises at least one infrared light-emitting diode, wherein the transmitter drives the at least one infrared light-emitting diode to transmit the infrared signal.

6. The car door opening detection system according to claim 1, wherein the transmitter further comprises a plurality of infrared light-emitting diodes and a plurality of visible light sources, and the number of the plurality of infrared light-emitting diodes is equal to the number of the plurality of visible light sources.

7. The car door opening detection system according to claim 1, wherein the sensor further comprises a light-filtering module to filter out a visible light.

8. The car door opening detection system according to claim 1, wherein the car circuit is a car door switch circuit.

9. The car door opening detection system according to claim 1, wherein the car circuit is a car light circuit.

10. A car door opening detection method for a car door opening detection system comprising a transmitter and a sensor disposed within a car and facing the transmitter, the car door opening detection method comprising:
electrically connecting the transmitter to a car circuit of the car, wherein the car circuit is electrically connected to a power source of the car, and when at least one car door of the car is opened, the car circuit is turned on to receive a power from the power source, and the transmitter is enabled to transmit an infrared signal;
receiving the infrared signal and transmitting a corresponding digital signal in response to the infrared signal by the sensor; and
receiving the corresponding digital signal, and when the corresponding digital signal is classified as a predetermined pattern, identifying that the at least one car door of the car is opened.

11. The car door opening detection method according to claim 10, further comprising:
decoding the corresponding digital signal to obtain a signal code;
determining whether the signal code is the same as a predetermined code value; and
when the signal code is the same as the predetermined code value, identifying that the corresponding digital signal is classified as the predetermined pattern and identifying that the at least one car door of the car is opened.

12. The car door opening detection method according to claim 10, further comprising:
obtaining a light intensity value according to the corresponding digital signal, and determining whether the light intensity value is larger than an intensity threshold; and
when the light intensity value is larger than the intensity threshold, identifying that the corresponding digital signal is classified as the predetermined pattern and identifying that the at least one car door of the car is opened.

13. The car door opening detection method according to claim 10, further comprises:
when identifying that the at least one car door of the car is opened, sending out a warning message to a wireless communication device through a communication module.

14. The car door opening detection method according to claim 10, wherein the transmitter further comprises at least one infrared light-emitting diode, wherein the transmitter drives the at least one infrared light-emitting diode to transmit the infrared signal.

15. The car door opening detection method according to claim 10, wherein the transmitter further comprises a plurality of infrared light-emitting diodes and a plurality of visible light sources, and the number of the plurality of infrared light-emitting diodes is equal to the number of the plurality of visible light sources.

16. The car door opening detection method according to claim 10, wherein the sensor further comprises a light-filtering module to filter out a visible light.

17. The car door opening detection method according to claim 10, wherein the car circuit is a car door switch circuit.

18. The car door opening detection method according to claim 10, wherein the car circuit is a car light circuit.
